(19) United States
(12) Patent Application Publication
(10) Pub. No.: US 2015/0115497 A1
(43) Pub. Date: Apr. 30, 2015

(54) PREPARING A PRECURED TREAD FOR APPLICATION TO A TIRE CARCASS

(71) Applicants: E. Bruce Colby, Greenville, SC (US); Dimitri G. Tsihlas, Greer, SC (US); Cesar E. Zarak, Simpsonville, SC (US); Metodi L. Ikonomov, Clermont-Ferrand (FR)

(72) Inventors: E. Bruce Colby, Greenville, SC (US); Dimitri G. Tsihlas, Greer, SC (US); Cesar E. Zarak, Simpsonville, SC (US); Metodi L. Ikonomov, Clermont-Ferrand (FR)

(73) Assignees: Michelin Recherche et Technique S.A., Granges-Paccot (CH); Compagnie Generale des Etablissements Michelin, Clermond-Ferrand (FR)

(21) Appl. No.: 14/381,473

(22) PCT Filed: Feb. 29, 2012
(86) PCT No.: PCT/US12/27116

§ 371 Date: Aug. 27, 2014

(51) Int. Cl. B29D 30/00

(52) U.S. Cl. CPC B29D 30/0005; B29D 30/0016; B29D 2030/0038
USPC 264/162; 425/28.1

(57) ABSTRACT

The present invention comprises methods and apparatus for preparing a tread for application to a tire carcass by abrading a bottom side of the tread. In particular, the tread has a thickness extending depthwise between a top side and a bottom side of the tread. The tread thickness extends in a longitudinal direction and in a lateral direction between opposing sides of the tread. The tread further includes a void extending within the tread thickness and an extension of the tread extending across a width of the void and as a portion protruding outwardly from the tread bottom side by a distance. Such methods include stretching the tread such that the width of the tread void increases and the distance by which the extension protrudes from the bottom side decreases. Such methods further include abrading the bottom side of the tread.

### BACKGROUND OF THE INVENTION

1. Field of the Invention

This invention relates generally to treads for retreaded tires, and more particularly, to the preparation and abrading of precured treads prior to application of the tread to a tire carcass.

2. Description of the Related Art

It is known to form precured tire tread for application to a tire carcass to form a retreaded tire. In preparing the tire tread for application to the tire carcass, it is known to abrade (i.e., buff) the bottom side of the tread to remove any contaminants or foreign material and promote proper adhesion and bonding of the tread to the tire carcass, or any bonding material arranged there between. Such a process may further roughen the tread bottom side to further promote proper adhesion and bonding. This abrading process is commonly performed using a rotating rasp or drum having abrading features, such as cutting blades or edges, an abrasive surface, or wire brushes, generally used to remove material across a full width of the tread bottom side.

There are instances, however, where the tread include one or more extensions protruding from the bottom side of the tread, where such extensions span the width of a void arranged within the tread thickness to connect opposing sides of the void. In such instances, employing the prior process of abrading the tread bottom side may not sufficiently abrade the bottom of the extensions and/or detrimentally affect the extensions when such extensions sufficiently protrude from the bottom side. One manner of abrading the bottom side is to selectively abrade around the extensions, but this process becomes cumbersome, especially when having to abrade different configurations of extensions and different treads, and avoids abrading the bottom of the extensions which may be otherwise desired. Therefore, there is a need to provide a simplified abrading process to more universally prepare variations of treads having the extensions as noted above protruding from the bottom side of a tread.

### SUMMARY OF THE INVENTION

The present invention includes methods and apparatus for preparing a tread for application to a tire carcass. Particular embodiments of such methods include providing a tread having a thickness extending depthwise between a top side configured to engage a ground surface during tire operation and a bottom side configured to attach to a tire carcass. The tread thickness extends in a longitudinal direction and in a lateral direction between opposing sides of the tread. The tread further including a void extending within the tread thickness and an extension of the tread extending across a width of the void and having a portion protruding outwardly from the tread bottom side by a distance. Such methods further include stretching the tread such that the width of the void increases and the distance by which the extension protrudes from the bottom side decreases, and abrading the bottom side of the tread.

Further embodiments of the invention comprise an apparatus for abrading a to or bottom side of a tread. The apparatus includes an abrading member configured to abrade the bottom of a tread. The apparatus further includes a pair of tread constraining units configured to engage opposing, spaced apart portions of the tread and a means for stretching the tread.

The foregoing and other objects, features and advantages of the invention will be apparent from the following more detailed descriptions of particular embodiments of the invention, as illustrated in the accompanying drawings wherein like reference numbers represent like parts of the invention.

### DETAILED DESCRIPTION OF THE DRAWINGS

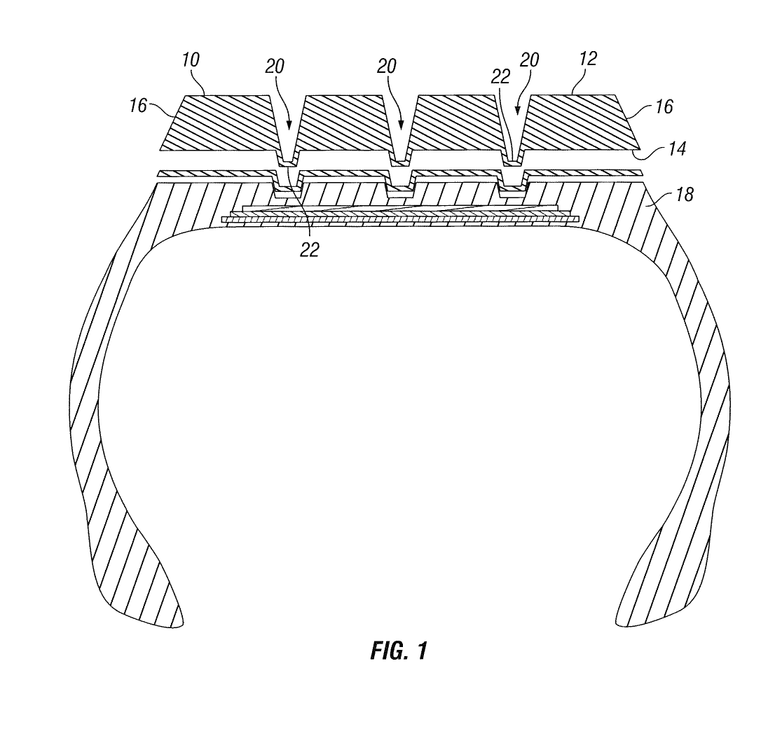

FIG. 1 is a front sectional view of a tire tread for arrangement on a tire carcass, the tread having a thickness containing voids comprising longitudinal grooves and extensions extending across a width of each void and protruding from the bottom side of the tread in accordance with a particular embodiment of the invention.

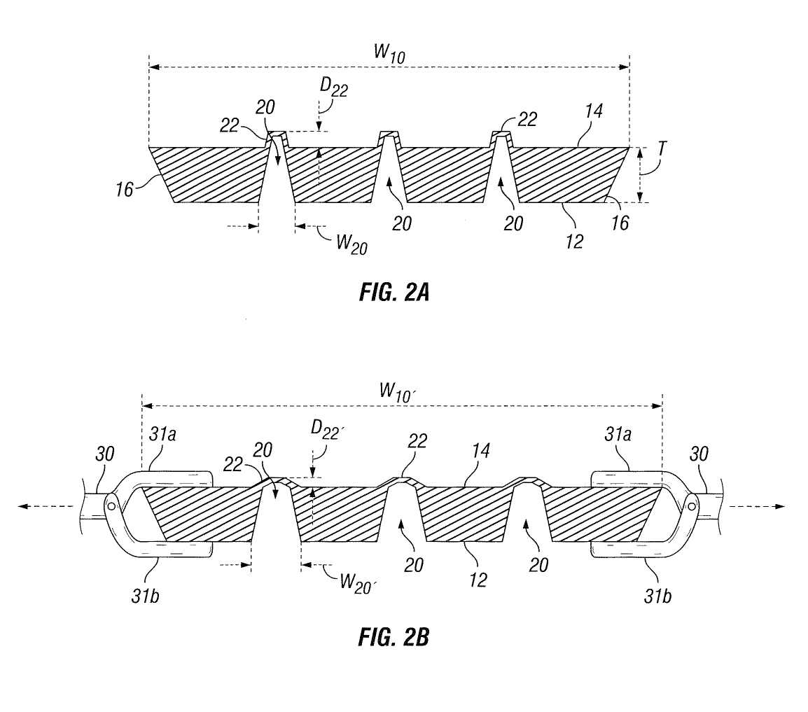

FIG. 2A is a front sectional view of the tread of FIG. 1, inverted for prior to performing an abrading operation along a bottom side thereof in accordance with a particular embodiment of the invention.

FIG. 2B is a front sectional view of the tread of FIG. 2A shown being constrained on opposing sides and stretched laterally by clamps to reduced the distance by which the bottom side tread extensions protrude outwardly from the bottom side in accordance with a particular embodiment of the invention.

FIG. 2C is a front sectional view of the tread of FIG. 2B being abraded by an abrading member comprising a rotary wire brush in accordance with an embodiment of the invention.

FIG. 2D is a front sectional view of the tread of FIG. 2B arranged atop a support structure and being abraded by an abrading member comprising a rasp having a texturized surface in accordance with an embodiment of the invention.

FIG. 2E is a front sectional view of the tread of FIG. 2B arranged atop an alternative support structure comprising a roller having an annular protrusion used to support the tread extension during abrading operations, in accordance with an alternative embodiment of the invention.

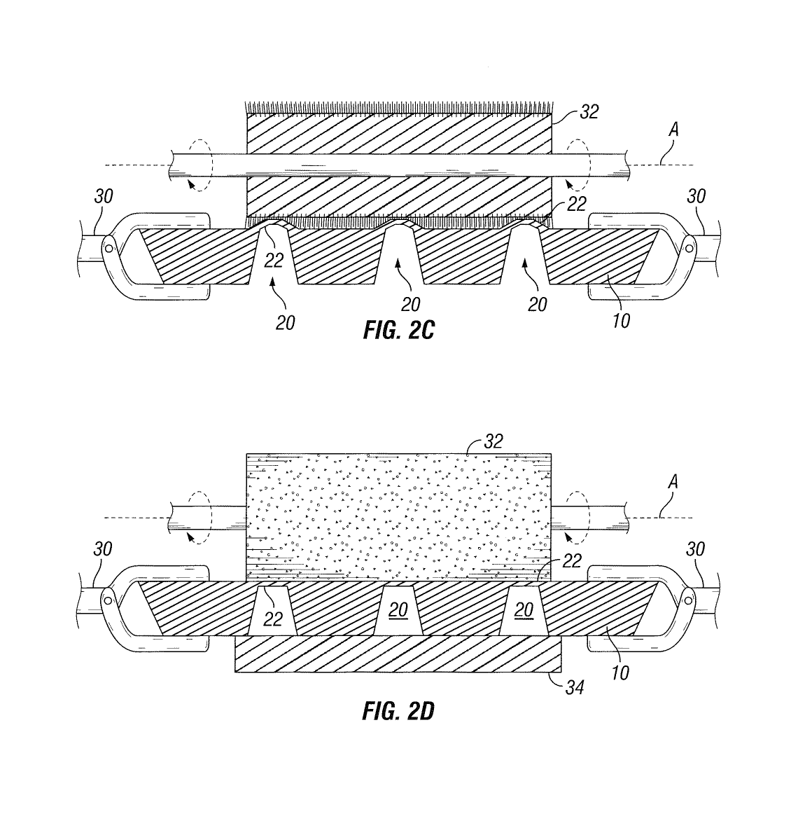

FIG. 3 is a top plan view of a tread stretching and abrading system in accordance with an embodiment of the invention.

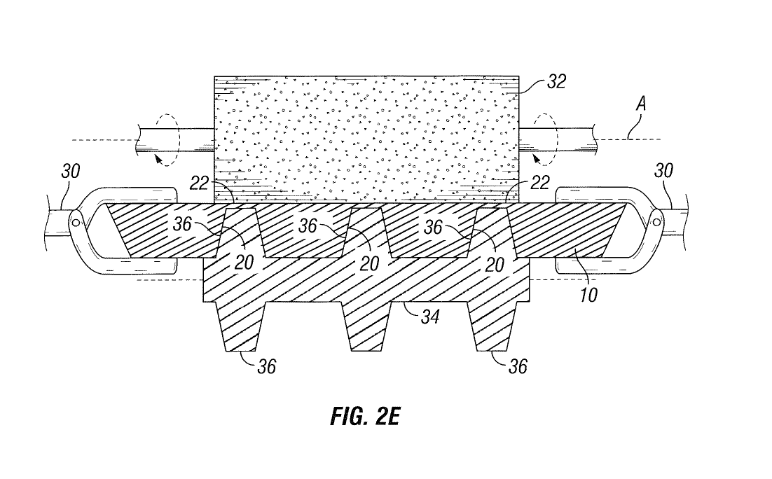

FIG. 4 is a top view of an outer conveyor more generally shown in FIG. 3 but without showing any constraining unit arranged thereon to more clearly show the conveyor, the outer conveyor including multiple links traveling along a path between a tread relaxation zone and a tread stretching zone in accordance with a particular embodiment of the invention.

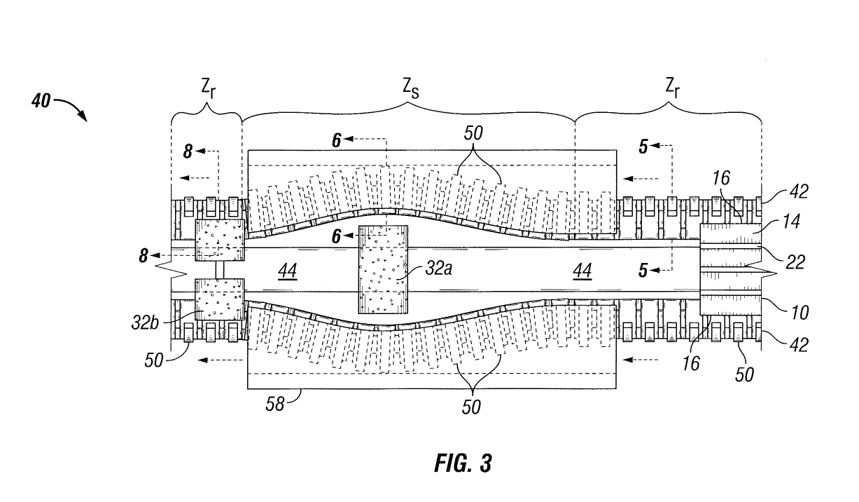

FIG. 5 is a sectional view taken along line 5-5 of FIG. 3, the view showing further details of a link arranged within the tread relaxation zone whereby the link includes a tread constraining means arranged thereon in an open, tread disengaged arrangement in accordance with a particular embodiment of the invention.

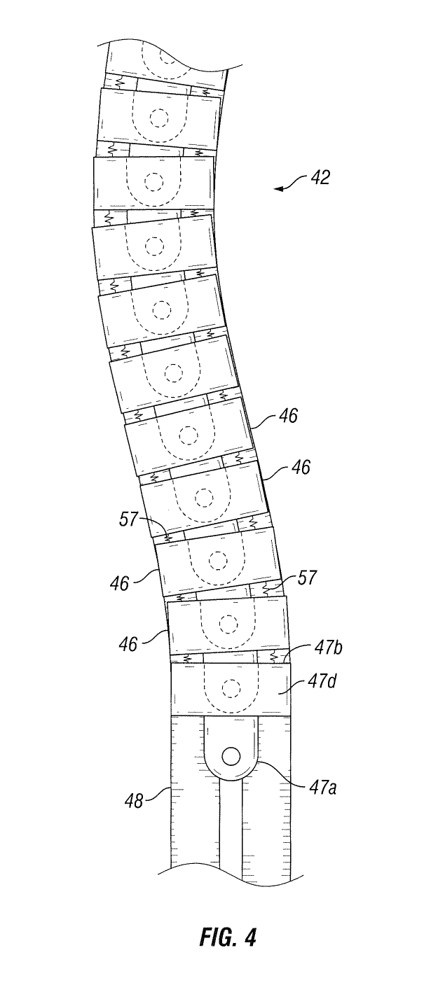

FIG. 6 is a sectional view taken along line 6-6 of FIG. 3, the view showing further details of a link arranged within the tread stretching zone whereby the tread constraining means arranged thereon is in a tread constraining or grasping arrangement and whereby the bottom side of the tread is being abraded by an abrading member in accordance with a particular embodiment of the invention.

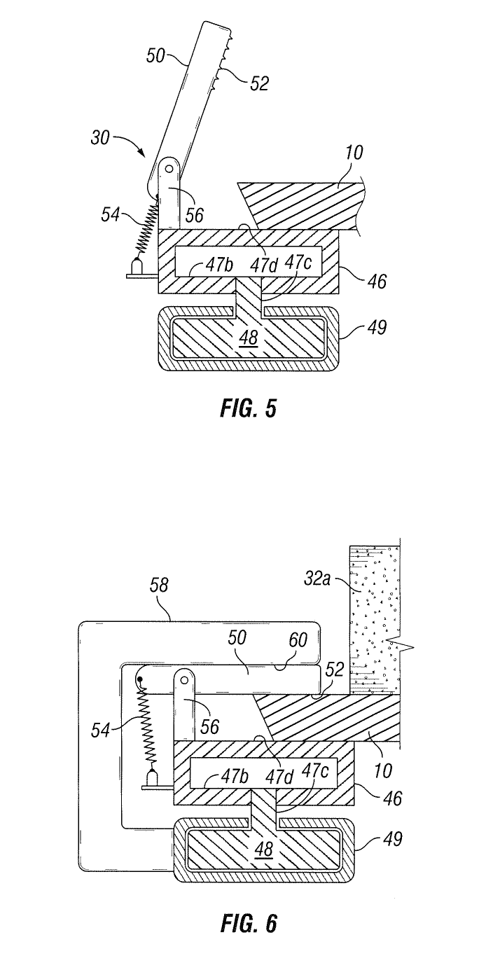

FIG. 7 is a sectional view taken along line 8-8 of FIG. 3, the view showing further details of a link arranged within the tread relaxation zone after departing from the tread stretching zone whereby the tread constraining means arranged thereon is in a tread disengaged arrangement and whereby the bottom side of the tread is being further abraded by a second abrading member along the sides of the tread that were not previously abraded in the stretching zone in accordance with a particular embodiment of the invention.

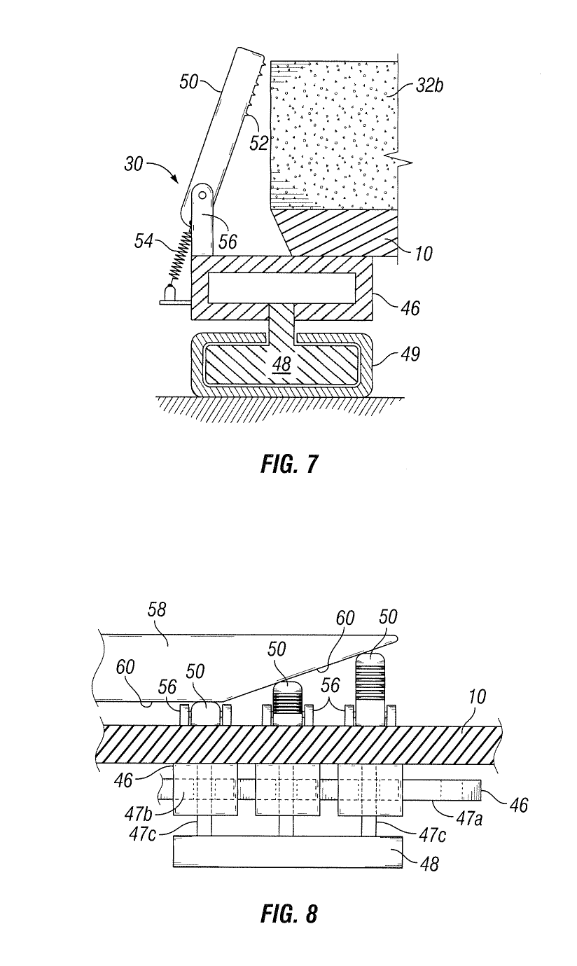

FIG. 8 is a side view of the outer conveyor of FIG. 3 showing the arms on successive links being progressively deflected downward by an arm displacing guide from a tread disengaged arrangement to a tread constraining or grasping arrangement as the links translate from right to left in accordance with a particular embodiment of the invention.

### DETAILED DESCRIPTION OF PARTICULAR EMBODIMENTS

Particular embodiments of the invention provide methods for preparing a tread for application to a tire carcass. When applying treads, such as precured treads, to a tire carcass, the bottom side of the tread is applied to a tire carcass or to a layer of bonding material (i.e., a bonding layer) arranged between the tread and carcass. The bottom side is then bonded to the tire carcass during a curing operation. Because proper adhesion is desired, the bottom side of the tread may be abraded (i.e., buffed) to remove any contaminants or foreign matter, and/or to roughen the bottom side surface to promote proper adhesion and bonding of the tread to the tire carcass. The methods of preparing a tread for application to a tire carcass provide an improved method of abrading the bottom side when particular extensions project from the bottom side of the tread.

Particular embodiments of such methods include the step of providing a tread having a thickness extending depthwise between a top side configured to engage a ground surface during tire operation and a bottom side configured to attach to a tire carcass. The tread thickness extends in a longitudinal direction and in a lateral direction between opposing sides of the tread. The tread further includes a void extending within the tread thickness and an extension of the tread extending across a width of the void, such as to form a boundary or terminal end of the void, and having a portion protruding outwardly from the tread bottom side by a distance. It is understood that the void may comprise any desired void. For example, the void may comprise a longitudinal groove extending generally in a lengthwise direction along any linear or non-linear path. By further example, the void may comprise a lateral void generally extending transverse or laterally relative a longitudinal direction of the tread (i.e., the tread centerline), along any linear or non-linear path. Furthermore, it is understood that the void may extend into the tread thickness from the top side or may be recessed below the top side. When extending inwardly from the top side, the void extends between the top side and the extension. It is also understood that the tread provided may form a strip of tread having a length extending between a pair of opposing terminal ends, or may comprise a tread ring whereby the tread has a length extending annularly.

Such methods may further include the step of stretching (which is also used synonymously with “expanding”) the tread such that the width of the void increases and the distance by which the extension protrudes from the bottom side decreases. Stretching the tread generally means expanding the tread in a widthwise and/or lateral direction to increase the width of any void arranged with the tread thickness, which in turn causes a corresponding extension protruding from the bottom side of the tread (and across the width of the void) to protrude less from the bottom side. This may include placing at least a portion of the tread thickness, including the extension, in tension.

It is understood that the tread may be stretched or expanded by any means for stretching, which may comprise any stretching means, member, or mechanism. For example, stretching may be achieved by pulling or pushing portions of the tread outwardly away from each other or away from fixedly constrained portions of the tread. Furthermore, because the void and extension may be arranged in any orientation relative a longitudinal direction of the tread, the tread may be stretched (i.e., expanded) in any direction. For example, when the void is a longitudinal groove, the tread is stretched or expanded laterally such that the overall width of the tread increases. By further example, when the void is a lateral groove, the tread may be stretched in a longitudinal direction.

In stretching the tread and increasing the width of a void, the extension deflects and in some cases even straightens with sufficient tension. This tension causes the extension to travel closer to the void and the bottom side of the tread, whereby the distance by which the extension protrudes from the bottom side decreases. Particular embodiments of stretching substantially decreases the distance by which the extension protrudes from the bottom side. As a result, previously protruding portions of the extension become more flattened to better facilitate abrading of the bottom, exposed side of the extension, which may also better protect the extension from any unintended damage that may occur during any abrading operation where the extension sufficiently protrudes from the bottom side, whereby the extension may become torn, lacerated, or otherwise damaged. In certain instances, stretching of the tread may reposition portions of the extension previously protruding from the bottom side within the void. Furthermore, by widening the void during stretching operations, the abrading means or mechanism may force portions of the extension into the void. In other words, in certain instances, widening the void facilitates direct or indirect repositioning at least a portion of the extension within the void to protect at least a portion of the extension from the abrading process. Direct repositioning occurs when stretching the tread causes at least a portion of the extension to be repositioned within the void. Indirect repositioning occurs when the widening of the void causes the extension to be more closely positioned to the void, which makes it easier for both the abrading member to deflect the extension into the void and the void to receive the extension (since its wider).

In particular embodiments, before the tread is stretched, such methods include constraining (i.e., securing) portions of the tread to facilitate stretching (i.e., expansion) of the tread, such as by pushing or pulling the tread into a stretched or expanded arrangement. Any means for constraining or securing a portion of the tread (that is, any constraining means, member, or mechanism) may be employed so that the tread may be stretched or expanded in the step of stretching, such as by pulling or pushing opposing portions or sides of the tread. For example, in particular embodiments, the step of constraining comprises grasping opposing sides or portions of the tread prior to stretching the tread. It is understood that any means for grasping any side or portion of the tread may be employed. For example, portions of the tread may be clamped or squeezed (and thereby constrained) by arranging a thickness of the tread between opposing members or surfaces, where at least one of the opposing members or surfaces moves, deflects, or expands towards the other, which may be fixed or also moveable, deflectable, or expandable. Opposing members or surfaces may be provided by any known clamp, which may be manually, mechanically, pneumatically, hydraulically, or electrically actuated, for example. Opposing members or surfaces may also comprise any combination of structures, such as plates, rollers, and drums, for example.

By further example, portions of the tread may be grasped, constrained, or secured using one or more frictional surfaces whereby the sufficient friction between the surface and the tread constrain the tread relative the surface. Frictional surfaces promote friction by including particulate, protrusions, texture, or other friction-producing material, compositions, elements, or members. The frictional surface may be used in lieu of any clamp or clamping operation, or in addition to or as a part of any clamp or clamping operation. Furthermore, a frictional surface may be associated with any desired structure, such as a plate, drum, or roller, for example.

In yet another example, portions of the tread may be grasped, constrained, or secured using one or more protrusions configured to extend into a thickness of the tread. Such one or more protrusions may be employed in addition to or in conjunction with any other manner or means of grasping or constraining. Furthermore, the one or more protrusions may extend from any desired flat or contoured surface associated with any desired structure, such as any plate, drum, or roller, for example. Moreover, one or more protrusions may extend into a void of the tread, such as a groove, to pull or push a portion of the tread. For example, the protrusion may be used to push a portion of the tread outwardly which in turn causes a more central portion of the tread to stretch between opposing constraining members.

Further embodiments of such methods may optionally include supporting the tread while performing the step of abrading. The tread may be supported by a support structure or member, for example, to maintain the tread in a desired shape or arrangement during abrading operations and/or to resist the forces being applied during abrading operations that may tend to displace the tread. In instances, when an abrading member is engaging the bottom side of the tread, the top side of the tread may be supported by any desired structure. A support structure may comprise, for example, one or more flat or contoured tables, conveyors, conveyor belts, rollers, flat plates, drums, rings or any other structure that is transversely and/or longitudinally flat, contoured, or otherwise shaped a particular application. For example, an annular tread ring may be inverted such that the top side of the tread is supported along a drum. By further example, the top side of an annular ring may be supported by a ring, as the bottom side is abraded by a more centrally located abrading means or member.

While the extension may be sufficiently abraded with the bottom side in preparation for application and bonding to a tire carcass, the extension maybe sufficiently abraded without being supported by the support structure, such as when the extension is under sufficient tension. Optionally, the support structure may have a protrusion extending outwardly there from that is shaped and arranged to extend into the void from the top side and engage the extension to support the extension during abrading operations. Such protrusion may have a constant width equal to or less than the expanded width of the void, or may have a variable width. For example, a variable width protrusion may initially have a width equal to or less than the initial (unexpanded) width of the void but which tapers gradually to a larger width at least equal to or less than the expanded void width. This variable width protrusion may be arranged on any desired support structure, and arranged on a flat surface or any contoured surface. Such a variable width protrusion may be employed to assist in widening the void and pushing the tread outward to stretch a more central portion of the tread.

Particular embodiments of such methods further include abrading the bottom side of the tread with at least a portion of the protruding portion positioned within the void. It is understood that any known means for abrading the bottom side capable of removing a desired depth of material from the tread may be employed. For example, the abrading means may comprise an abrading member that is rotational, such as a rasp, grinding wheel, or rotary wire brush. By further example, the abrading member may comprise textured surface or a blade that may remain stationary (such as when the tread is in motion) or may translate relative to the tread. It is understood that one or more abrading means or members may be employed to abrade the bottom side while the tread is stretched. Furthermore, if any portion of the tread bottom side is covered or otherwise in accessible during the abrading operation, such as when a portion of the tread is used to grasp the tread to facilitate tread stretching, any unabraded portion of the bottom side may be abraded before or after the tread is abraded in a stretched arrangement. It is also understood that the bottom side of the tread and any extensions may be abraded even if the tread is not stretched. In such instances, the extension may continue to protrude from the bottom side during the abrading operation, such as when the extension protrudes minimally or in sufficiently from the bottom side, when the abrading means is able to conform at least partially to the extension, and/or when the abrading means or mechanism is able to deflect at least a portion of the extension into the void without widening the void.

Such methods may further include conveying or transporting the tread to and from one or more stretching members for performing the step of stretching. Such conveyance may be achieved by any desired motion or movement, which includes translating and/or rotating the tread. Furthermore, the step of conveying may be accomplished using any means for conveying, including employing one or more conveyors.

It is understood that these methods generally discussed, as well as any apparatus or system described below, may be employed to abrade a top side of a tread should the need arise, regardless of whether an extension as provided herein protrudes from the bottom side. Likewise, the bottom side of the tread may be abraded by these methods and any apparatus or system described herein regardless of whether an extension protrudes from a bottom side of the tread. Particular embodiments of the methods discussed above will now be described in further detail below in association with the figures filed herewith exemplifying the performance of the methods in association with particular embodiments and apparatus.

With reference to FIG. 1, an exemplary tread 10 is shown having an extension 22 protruding from a bottom side 14 of the tread and extending across a corresponding void arranged within a thickness of the tread. In particular, the tread includes a thickness T extending depthwise between a top side 12 configured to engage a ground surface during tire operation and a bottom side 14 configured to attach to a tire carcass 18. The tread 10 and its thickness T extend transversely in both a longitudinal direction, which is also the lengthwise direction of the tread, and in a lateral direction between opposing lateral sides 16 of the tread to form a width W₁₀ of the tread. A plurality of voids 20 are also shown extending within the tread thickness T, the tread extensions 22 extending across a width W₂₀ of the void to form a boundary of the void and having a portion protruding outwardly from the tread bottom side by a distance D₂₂.

In the embodiment shown, voids 20 are longitudinal grooves extending in a longitudinal or lengthwise direction of the tread. The voids 20 shown also extend into the tread thickness from a top side 12 of the tread. It is understood, however, as discussed above, a void 20 may comprise any desired void arranged within the tread thickness such that an extension 22 protruding from the tread bottom side 14 is arranged adjacent to the void, whereby the extension spans the width of said void to thereby connect tread arranged on opposing sides of the void. For example, the void, such as a groove, may be recessed from the top side to form a submerged void. In particular variations, a sipe or small groove may be arranged to extend into the tread thickness from the tread top side between the top side and the void. Furthermore, any void may extend lengthwise in any direction of the tread, and in particular may form longitudinal or lateral grooves.

In the embodiment shown, extensions 22 define a boundary or terminal end of void 20. In doing so, extensions connect the tread on opposing sides of the void width. In the embodiment shown, extensions 22 form U-shaped extensions of the tread, although it is understood that an extension may comprise any desired shape and may extend from any location of the tread, such as, for example, from within void 20 (e.g., from opposing sides of the void) or from a location outside the void (e.g., along the bottom side adjacent opposing sides of the void), provided that the extension protrudes outwardly from the bottom side 14 and across a width of the void. Furthermore, an extension may extend continuously along a full length of the void, or multiple extensions may be spaced apart along a length of the void. When multiple extensions are employed, each such extensions may extend across the width of any void in any direction and in any form or shape so long as the extension connects the sides of the void.

The tread 10 in FIG. 1 is shown to be configured to engage a tire carcass 18 having recesses 19 for receiving the tread extensions 22. This is but one possible use of a tread having extensions, as it is understood that such a tread having extensions may be applied to a tire carcass free of such recesses, such as when the extensions are sufficiently thin or are designed to deflect into the void, or when the extensions are removed prior to applying the tread to the tire carcass.

Because the tread is bonded to the tire carcass, the bottom side of the tread is typically cleaned and roughened to promote proper adhesion and bonding of the tread to the tire carcass or any intermediate bonding material arranged there between. Such cleaning and roughening may be achieved by abrading (that is, buffing) the bottom side of the tread prior to application to the tire carcass. Abrading may be accomplished by any known abrading means, such as a rasp having blades or a drum having a texturized surface or wire brushes extending there from, for example. Abrading may be performed manually, such as by use of a hand tool, or may be performed by way of an automated machine or the like.

To better facilitate abrading of the tread bottom side and the bottom surface of any extensions, and without damaging or separating any such extensions from the tread, the tread is stretched as discussed above to reduce the distance by which the extensions protrude from the bottom side. In certain instances, this allows at least a portion of each extension to be repositioned within the void to protect and at least partially preserve the integrity of each extension during abrading operations. While a portion of the extension may in-fact be abraded during an abrading operation, at least a portion of the extension received by the void is preserved.

With reference to FIG. 2A, an exemplary tread 10 having extensions 22 as discussed above is provided. The tread may be arranged in any orientation as desired to accomplish the stretching and abrading operations. For example, with further reference to FIG. 2A, the tread 10 may be inverted such that the top and bottom sides 12, 14 of the tread are interchanged elevationally. This reorientation may be desired when, for example, with reference to FIG. 2C, an abrading member 32 is configured to abrade a tread positioned below the abrading member. In such instances, with reference to FIGS. 2D and 2E, for example, the tread may be arranged atop a supporting structure 34, such as a table, conveyor, or drum, to resist any downward force applied to the tread by way of the abrading member.

With reference to FIG. 2B, the tread of FIG. 2A is shown in a stretched or expanded arrangement having an increased width W₁₀′. In this stretched arrangement, the width W₂₀ of each void has increased from a relaxed state to an increased width W_{20′} while the distance D₂₂ by which the tread extension 22 protrudes from the bottom side 14 has decreased to a reduced distance D_{22′}. Stretching of the tread may be achieved by any known stretching means (which is also referred to as a stretching member or mechanism). For example, in the embodiment of FIG. 2B, stretching is achieved by first mechanically securing opposing lateral sides of the tread by constraining or securing each side with a constraining or securing means 30. In particular, the means for constraining is shown to comprise a pair of constraining units, such units forming grasping means. In the embodiment shown, each grasping means 30 is a clamp (whereby a pair of clamps are shown). In particular, each clamp comprises a pair of members 31a, 31b arranged on opposing sides of the tread thickness, the members comprising any structure being displaceable between tread engaged and disengages arrangements. Such members 31a, 31b are shown to be operably associated in hinged relation, however, it is understood that members may be separately arranged and independently displaceable. By further example, securing means may comprise a member that engages a surface of the tread, whereby the member has an abrasive surface that frictionally grips the tread or one or more protrusions that penetrate into a thickness of the tread to grip the tread.

Upon securement, the stretching means displaces a secured portion of the tread away from the opposing secured tread portion such that a desired thickness of the tread is in tension in any desired longitudinal and/or lateral direction to widen a target void and reduce the distance by which the tread extension protrudes from the bottom side. In the embodiment of FIG. 2B, the tread 10 is being stretched laterally by moving the constraining or grasping means 30 outwardly relative the tread such that voids 20 have an increased width W_{20′} and extensions 22 protrude a reduced distance D_{22′} from the tread bottom side 14. In doing so, the extensions may also be placed under tension, and as a result, the extensions become more flattened (i.e., protrude less from the bottom side). In particular embodiments, portions of extensions 22 previously protruding from the bottom side 14 may be repositioned within the void 20 (i.e., below the bottom side) if desired, such as due to further stretching or by deflecting the extensions into the void by way of the abrading means or mechanism (which is shown in an exemplary embodiment in FIGS. 2D and 2E).

To displace the tread as desired, stretching means includes a means for displacing the tread (which is also referred to as a displacing means, member, or mechanism) and any constrained portion thereof outwardly away from a central portion of the tread. This may include displacing the constraining or grasping means 30 with the constrained portion of the tread. It is understood that displacing means may comprise any manual or automatic means for forcefully displacing the tread, and which may achieve the desired displacement by any desired motion, such as translation and/or rotation. For example, the tread may be manually pulled, or may be mechanically pulled by any device or system. By further example, with reference to FIG. 2B, grasping means 30 may be directly or indirectly translated or rotated by a pneumatic or hydraulic cylinder, by a cam, or by a lever. Yet another example, the system shown in FIG. 3 (discussed further below) employs a track 49 and conveyor 42 to displace a grasping means and achieve the desired tread displacement. In any event, it is understood that both sides of the tread may be displaced during stretching operations, as suggested in FIG. 2B, or one side of the tread may remain fixedly constrained while the other side is displaced by a means for stretching.

Once stretched, the bottom side of the tread may be abraded by any desired means for abrading (also referred to as an abrading means, member, or mechanism). With reference to FIG. 2C, an abrading means 32 comprising a rotating wire brush is applied to the bottom side to remove any foreign matter and, if desired, a desired amount of tread material from the bottom side 14. In operation, according to particular embodiments with reference to FIG. 2D, as the abrading means 32 is being applied to engage the tread or during an abrading operation, the abrading means may further aid in deflecting or repositioning any protruding portion of extension 22 into the void 20. To provide a stable surface upon which the tread may be abraded, a support structure 34 is arranged opposite the abrading means 32 relative the tread thickness T. In the embodiment shown, the tread top side 12 placed atop support structure 34. It is understood that one or more support structures may be employed to support the tread. It is also understood that the support structure may remain fixed or the support structure may translate or rotate, such as when the support structure is a conveyor, drum, or roller, for example. Optionally, with reference to FIG. 2E, any desired support structure 34, such as the roller shown, may include a protrusion 36 configured to extend into a void 20 from a top side to engage and support the extension during abrading operations. The protrusion 36 shown extends annularly about the roller 34 and has a width approximately equal to the width W_{20′} of the widened void 20′, but as mentioned above, may comprise any width, including any width equal to or less than the widened width W₂₀′. Furthermore, protrusion 36 may support an extension 22 that is configured in any arrangement, such as when at least partially protruding from the bottom side, or when repositioned within the void as exemplarily shown in FIG. 2E.

With reference now to FIG. 3, a particular embodiment of an apparatus or system 40 for abrading a bottom side of a tread having extensions is shown. The system shown translates the tread 10 along a conveyor system, whereby the tread is stretched laterally as outer conveyors 42 deviate laterally outwardly relative the tread in a stretching zone Zₛ of the conveyor system between relaxation zones Zᵣ. While in a stretched arrangement, a central portion of the tread bottom side is abraded by a first abrading means 32a. The central portion of the bottom side refers to a portion of the bottom side inward each of the lateral sides 16. Because the grasping means extends partially along the bottom side while grasping the tread, such portion of the tread is unable to be abraded when the tread is in a stretched arrangement. Therefore, after the tread is relaxed and returned to its unstretched state in a relaxation zone Zᵣ, the unabraded portions of the bottom side are then abraded by one or more second abrading means 32b arranged downstream of the first abrading means. It is understood, however, that the portions of the bottom side that will be grasped by the grasping means and will therefore not be abraded by the first abrading member may be abraded before the tread is stretched and abraded by the first abrading means. In such instances, the one or more second abrading means 32b is arranged upstream of the first abrading means 32a. A central conveyor or support structure 44 may be arranged between the outer conveyors 42 to support the tread during the abrading operations.

With reference now to FIGS. 4-8, a particular embodiment of the outer conveyor is shown and described in more detail. With particular reference to FIG. 4, an outer conveyor 42 comprising a linkage is shown traveling between a relaxed tread zone and the tread stretching zone. In particular, the outer conveyor 42 (comprising a linkage) is shown to comprise a plurality of pivotable links 46 translating along a track 49. The links 46 may be driven by any known means (not shown), such as a motor, that drives a belt, chain, or the like, in operable connection to one or more of the links, such as via attachment. The belt, chain, or the like may be arranged within or below the track 49, and may form a continuous loop or path along which the outer conveyor (or linkage) travels. While the links include a means for securing the tread (shown in FIGS. 5-8 with links), the securing means is not shown in FIG. 4 to more clearly describe the conveying means.

With reference now to FIGS. 5-8, the securing means 30 of the links 46 are shown and their operation described. Generally, the figures show a link 46 having a grasping means 30 arranged along a top side 47d of the link, the grasping means comprising a pivotable arm 50 pivotally attached to a fixture 56 coupling the arm to the link. A displaceable biasing means 54, such as a spring, cylinder, or the like, is operably attached to the pivotable arm 50 such that a tread engaging portion 52 of the arm is biased in a tread disengaged arrangement as is most clearly shown in FIG. 5. Tread engaging portion is shown to include a plurality of protrusions for improved grasping of the tread; however, in lieu thereof a generally flat surface may be texturized to also improve grasping capabilities. As the link travels along the conveyor and into the stretching zone, the tread engaging portion 52 of the arm engages an arm displacement guide 58, which downwardly displaces the tread engaging portion until reaching a tread securing arrangement, which is most clearly shown in FIG. 6. In doing so, as the tread engaging portion 52 rotates downwardly, the arm 50 pivots and the biasing member 54 deflects. In the tread securing arrangement, the tread is secured between the arm and the top side 47d of the link. Once secured just prior to the stretching zone, the tread is stretched as the outer conveyor 42 travels outwardly from the relaxation zone and into the stretching zone. And once sufficiently stretched, the protruding extensions 22 are at least partial received by a corresponding void 20 and the tread bottom side is abraded by first abrading means 32a. Subsequently, as the outer conveyer 42 deviates inwardly to return to a tread relaxation zone after the central portion of the tread has been abraded by first abrading means 32a (see FIG. 3), the arm 50 returns to a tread disengaged arrangement by way of the biasing means 54 after the arm disengages from displacement guide 58, which is most clearly shown in FIG. 7. In operation, the securing means of the outer conveyor operates more generally as a cam. This is more clearly shown in FIG. 8, where a side view of outer conveyor depicts the arm displacement guide 58 causing the arm 50 of each successive link 46 downward from a tread disengaged arrangement to a tread securing arrangement as the links enter the stretching zone (where the links translate from right to left in the figure). In FIG. 8, the arm displacement guide 58 has a contoured or variable height arm engaging portion 60 that begins to gradually displace arms 50 prior to entering the stretching zone, so that each arm can be in the tread securing arrangement before any link 46 travels outwardly along track 49 to stretch the tread. It is understood that other variations of this outer conveyor may be employed while maintaining the spirit of the invention.

As mentioned above, links may comprise any known links forming any desired linkage having a means for securing or grasping a tread. Exemplary links are shown in more further detail in FIGS. 4-8. With reference to FIGS. 4 and 8, each link 46 generally includes first and second connection portions 47a, 47b for pivotally connecting adjacent links within the linkage or conveyor 42. More specifically, first connection portion 47a is inserted into the second connection portion 47b of an adjacent link. A pin or the like extends through apertures arranged in each to pivotally connect adjacent links. The first and second connecting portions 47a, 47b are operably attached to a base 48 that is slidably retained within track 49. Base 48 is shown to be continuous, such as to form a belt, band, chain, or the like, which may be driven by any known means. It is understood that base 48 may be discontinuous, and may be divided into segments separately associated with each link 46 and fixedly or pivotally attached to any portion 47a, 47b (which together is referred to a top portion of the link). In the embodiment shown, portions 47a, 47b are pivotally attached to base 48 by way of connector 47c. Connector 47c may form a portion of link 46 or base 48, or may be independent thereof. Because link is able to pivot in a direction perpendicular the tread bottom side, it may be desired to ensure that that means for constraining the tread 50 returns to a desired arrangement relative the tread. Therefore, a biasing mechanism or centering mechanism 57, such as springs or the like, may be employed by links 46 to arrange any constraining unit 50 in a desired arrangement when disengaged from tread 10 and prior to engaging or constraining tread 10.

To facilitate translation of base within track 49, base may be formed of or coated with a low friction material. Optionally, bearings, rollers, or wheels (not shown) may be positioned between the base and the track to further promote fluent translation of the base within track 49. As stated above, any know means may be provided to drive the plurality of links (i.e., linkage) along a closed path forming the outer conveyor. For example, such means may comprise a chain, belt, or the like, driven by a motor by way of a transmission shaft, gear, or sprocket the like, whereby said chain, belt, or the like is connected to each base member. By further example, a continuous, closed-loop base may be provided that operates as a chain, belt, or the like that is driven by a motor—where, in such instance, the first and second connection members are pivotally attached to the base in lieu of the rigid connection shown in the figures. Of course, any other means of translating the links may be employed, including electromagnetic propulsion.

The present invention may be utilized in association with retreaded heavy duty truck or trailer tires. Heavy duty truck tires include steer and drive tires. Nevertheless, the present invention may be utilized in association with any type of tire to form any new or retreaded tire and as such, any type of tire may provide an embodiment of the present invention. Exemplary tire types for use with the subject invention further include light truck tires, off the road tires, bus tires, aircraft tires, bicycle tires, motorcycle tires, and passenger vehicle tires.

The terms “comprising,” “including,” and “having,” as used in the claims and specification herein, shall be considered as indicating an open group that may include other elements not specified. The terms “a,” “an,” and the singular forms of words shall be taken to include the plural form of the same words, such that the terms mean that one or more of something is provided. The terms “at least one” and “one or more” are used interchangeably. The term “single” shall be used to indicate that one and only one of something is intended. Similarly, other specific integer values, such as “two,” are used when a specific number of things is intended. The terms “preferably,” “preferred,” “prefer,” “optionally,” “may,” and similar terms are used to indicate that an item, condition or step being referred to is an optional (i.e., not required) feature of the invention. Ranges that are described as being “between a and b” are inclusive of the values for “a” and “b” unless otherwise specified.

While this invention has been described with reference to particular embodiments thereof, it shall be understood that such description is by way of illustration only and should not be construed as limiting the scope of the claimed invention. Accordingly, the scope and content of the invention are to be defined only by the terms of the following claims. Furthermore, it is understood that the features of any specific embodiment discussed herein may be combined with one or more features of any one or more embodiments otherwise discussed or contemplated herein unless otherwise stated.

1. A method for preparing a tread for application to a tire carcass, the method comprising:
providing a tread having:
a thickness extending depthwise between a top side configured to engage a ground surface during tire operation and a bottom side configured to attach to a tire carcass;
the tread thickness extending in a longitudinal direction and in a lateral direction between opposing sides of the tread;
the tread further including a void extending within the tread thickness and an extension of the tread extending across a width of the void and having a portion protruding outwardly from the tread bottom side by a distance;
stretching the tread such that the width of the void increases and the distance by which the extension protrudes from the bottom side decreases; and,
abrading the bottom side of the tread.

2. The method of claim 1, the void comprises a groove.

3. The method of claim 2, the groove extending into the tread thickness from the top side between the top side and the extension.

4. The method of claim 2, the groove extending lengthwise in a longitudinal direction of the tread, the tread being stretched in a lateral direction in the step of stretching.

5. The method of claim 1, where the step of abrading is performed with at least a portion of the protruding portion positioned within the void.

6. The method of claim 1, where the extension is stretched during the step of stretching.

7. The method of claim 1, where the step of stretching repositions at least a portion of the protruding portion within the void.

8. The method of claim 1 further comprising the step of:
applying an abrading member to the bottom side, the abrading member deflecting at least a portion of the protruding portion of the extension into the void.

9. The method of claim 1 further comprising the step of:
supporting the top side of the tread while performing the step of abrading.

10. The method of claim 1, the tread having a length extending between a pair of opposing terminal ends.

11. The method of claim 1 further comprising the step of:
constraining opposing portions of the tread prior to stretching the tread.

12. The method of claim 11, the step of constraining being performed by grasping at least one of the opposing portions.

13. The method of claim 12, where the grasping is performed by a pair of opposing clamps.

14. The method of claim 12, where the step of stretching includes moving a constraining member used to constrain one of the opposing portions of the tread.

15. (canceled)

16. An apparatus for abrading a bottom side of a tread comprising:
an abrading member configured to abrade the bottom of a tread;
a pair of tread constraining units configured to engage opposing, spaced apart portions of the tread;
a means for stretching the tread wherein at least one of the pair of tread constraining units is moveable and the means for stretching is configured to move the at least one of the pair of tread constraining members away from the other tread constraining unit.

17. The apparatus of claim 16, wherein the abrading member is a rotational abrading member.

18. The apparatus of claim 16, wherein at least one of the pair of tread constraining units is a tread grasping member.

19. (canceled)

20. The apparatus of claim 16, wherein the pair of tread constraining units comprises a pair of clamps.

21. The apparatus of claim 16 further comprising:
a conveyor configured to transfer the tread to and from the abrading member.

22. The apparatus of claim 20, where each of the pair of clamps is operably connected to a conveyor configured to transfer the tread to and from the abrading member.
